(19) United States
(12) Patent Application Publication
(10) Pub. No.: US 2022/0114407 A1
(43) Pub. Date: Apr. 14, 2022

(54) METHOD FOR INTERMEDIATE MODEL GENERATION USING HISTORICAL DATA AND DOMAIN KNOWLEDGE FOR RL TRAINING

(71) Applicant: International Business Machines Corporation, Armonk, NY (US)

(72) Inventor: Alexander Zadorojniy, Haifa (IL)

(21) Appl. No.: 17/068,116

(22) Filed: Oct. 12, 2020

(51) Int. Cl. G06K 9/62; G06N 20/00

(52) U.S. Cl. CPC G06K 9/6297; G06N 20/00; G06K 9/6264

(57) ABSTRACT

Embodiments may include novel techniques for intermediate model generation using historical data and domain knowledge for Reinforcement Learning (RL) training. Embodiments may start with gathering client data. For example, in an embodiment, a method, implemented in a computer system comprising a processor, memory accessible by the processor, and computer program instructions stored in the memory and executable by the processor, may comprise identifying historical data and domain knowledge of a client including mathematical properties of features, generating an intermediate model comprising a probabilistic description of the environment, such as an MDP graph or transition probability matrix based on the identified historical data and domain knowledge, training a Reinforcement Learning (RL)/Deep Reinforcement Learning (DRL) model using the generated intermediate model, and deploying the trained Reinforcement Learning (RL)/Deep Reinforcement Learning (DRL) model and continuing training the trained Reinforcement Learning (RL)/Deep Reinforcement Learning (DRL) model from a real environment.

### BACKGROUND

The present invention relates to novel techniques for intermediate model generation using historical data and domain knowledge for Reinforcement Learning (RL) training.

The constrained Markov Decision Process (CMDP) is a five tuple of the finite set of states, finite set of actions, transition probability matrix, immediate cost function, and immediate vector of costs for constraints. Given this tuple, the optimization problem is defined as the minimization of cost such that all constraints are satisfied. Back in the 1960s, it was known that a CMDP could be formulated as a linear program (LP). The CMDP framework, despite being around since the 1950s and extensively studied in theory, is not widely used in practice. The main reasons are the “curse of dimensionality” of state space and the difficulty of transition probability matrix estimation as well as rewards.

More recently, it has been shown that the CMDP approach is practical, for example, applying CMDP to a waste-water treatment plant (WWPT) operational control problem. The solution provided an optimal policy that satisfied all the safety constraints. However, the drawback of these techniques is that they rely on usage of a calibrated model what is not widely available.

Deep Reinforcement Learning (DRL) is represented with algorithms that can deal with high dimensionality and using efficient sampling methods and don't have to rely on the designated model. However, they are computationally expensive, data intensive, and safety is not trivial to guarantee. There are several practically promising DRL research directions. For example: (a) learning from historical data without explorations (e.g., batch learning). However, there are limitations to the most frequently used techniques for these types of problems, such as Deep Q-learning Networks (DQN) and Deep Deterministic Policy Gradient (DDPG), although it has been suggested that Batch-Constrained deep Q-learning (BCQ) can overcome some of these limitations. However, BCQ has no usage of client's domain available information. Another example is (b) aggregation of model-based and model-free approaches to speed-up convergence. A proposed deep Dyna-Q algorithm combines these two approaches. However, they don't incorporate historical data. A further example is (c) Safe-RL to address safe learning in-real life applications. It has been suggested that using a Lyapunov function in the training process may provide an improvement in balancing between objective improvement and constraint satisfaction. However, this approach is lacking in usage of historical user's data as well.

Accordingly, a need arises for improved techniques for intermediate model generation using historical data and domain knowledge for Reinforcement Learning (RL) training.

### SUMMARY

Embodiments may include novel techniques for intermediate model generation using historical data and domain knowledge for Reinforcement Learning (RL) training. Embodiments may start with gathering client data. This may be interpolated using domain knowledge information. This augmented data may be used to generate a probabilistic description of the environment, such as a transition probability matrix of the Markov Decision Process (MDP) or MDP graph. The MDP graph may be used to create an intermediate model for DRL initial training. This environment may be extremely fast to get samples from and any DRL algorithms may be used to train from it, including on-policy algorithms.

For example, in an embodiment, a method, implemented in a computer system comprising a processor, memory accessible by the processor, and computer program instructions stored in the memory and executable by the processor, may comprise identifying historical data and domain knowledge of a client including mathematical properties of features, generating an intermediate model comprising an MDP graph based on the identified historical data and domain knowledge, training a Reinforcement Learning (RL)/Deep Reinforcement Learning (DRL) model using the generated intermediate model, and deploying the trained Reinforcement Learning (RL)/Deep Reinforcement Learning (DRL) model and continuing training the trained Reinforcement Learning (RL)/Deep Reinforcement Learning (DRL) model from a real environment.

In embodiments, generating an intermediate model may comprise estimating at least one transition probability matrix using the identified historical data and domain knowledge, selecting an initial state of the process, generating at least one next state transition, and recording the generated at least one next state transition. The at least one transition probability matrix may be estimated by interpolating the identified historical data. Interpolating the identified historical data comprises at least one of neighboring state interpolation, absorbing state adjustment, neighboring state interpolation for action independent variables, and irreducibility adjustment. The at least one next state transition may be generated according to the transition probability matrix, a current state, and a chosen action and recording the generated at least one next state transition comprises recording a current state, a next state, a chosen action, and a reward. At least one transition probability matrix may comprise a pair of states and actions and an immediate cost or reward is defined for each state and action pair. The initial state of the process may be selected either deterministically or randomly.

In an embodiment, a system may comprise a processor, memory accessible by the processor, and computer program instructions stored in the memory and executable by the processor to perform identifying historical data and domain knowledge of a client including mathematical properties of features, generating an intermediate model comprising an MDP graph based on the identified historical data and domain knowledge, training a Reinforcement Learning (RL)/Deep Reinforcement Learning (DRL) model using the generated intermediate model, and deploying the trained Reinforcement Learning (RL)/Deep Reinforcement Learning (DRL) model and continuing training the trained Reinforcement Learning (RL)/Deep Reinforcement Learning (DRL) model from a real environment.

In an embodiment, a computer program product may comprise a non-transitory computer readable storage having program instructions embodied therewith, the program instructions executable by a computer, to cause the computer to perform a method comprising identifying historical data and domain knowledge of a client including mathematical properties of features, generating an intermediate model comprising an MDP graph based on the identified historical data and domain knowledge, training a Reinforcement Learning (RL)/Deep Reinforcement Learning (DRL) model using the generated intermediate model, and deploying the trained Reinforcement Learning (RL)/Deep Reinforcement Learning (DRL) model and continuing training the trained Reinforcement Learning (RL)/Deep Reinforcement Learning (DRL) model from a real environment.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary flow diagram of processing according to embodiments of the present techniques.

FIG. 2 illustrates an exemplary diagram of an intermediate model defined as a directed weighted graph, according to embodiments of the present techniques.

FIG. 3 illustrates an example of a transition probability matrix and corresponding vector of costs according to embodiments of the present techniques.

FIG. 4 illustrates an exemplary process for next state transition generation according to embodiments of the present techniques.

FIG. 5 is an exemplary block diagram of a computer system, in which processes involved in the embodiments described herein may be implemented.

### DETAILED DESCRIPTION

Embodiments may include novel techniques for intermediate model generation using historical data and domain knowledge for Reinforcement Learning (RL) training. Embodiments may start with gathering client data. This may be interpolated using domain knowledge information. This augmented data may be used to generate a transition probability matrix of MDP (or MDP graph). The MDP graph may be used to create an intermediate model for DRL initial training. This environment may be extremely fast to get samples from and any DRL algorithms may be used to train from it, including on-policy algorithms.

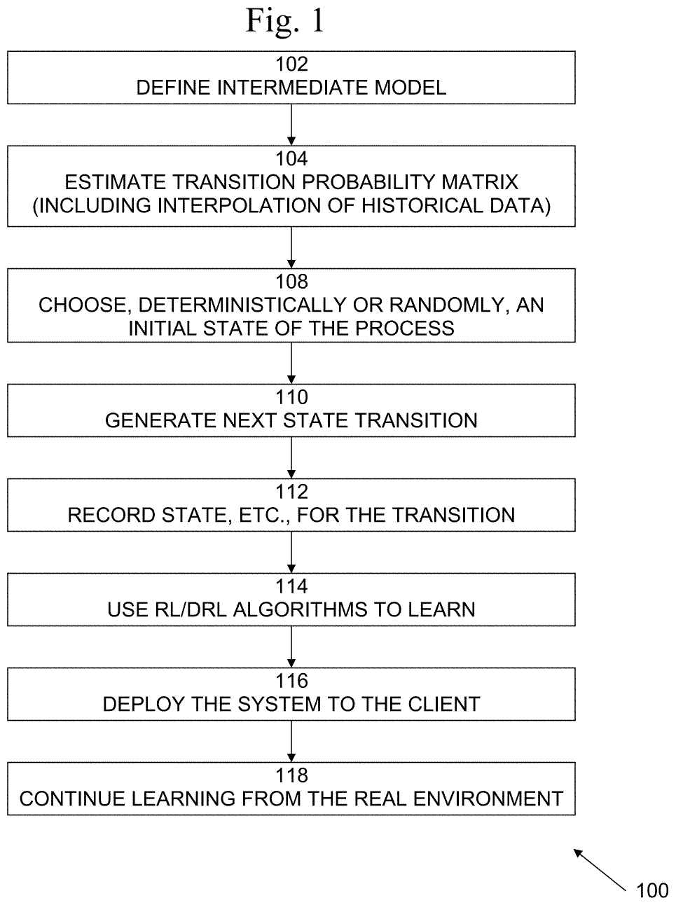

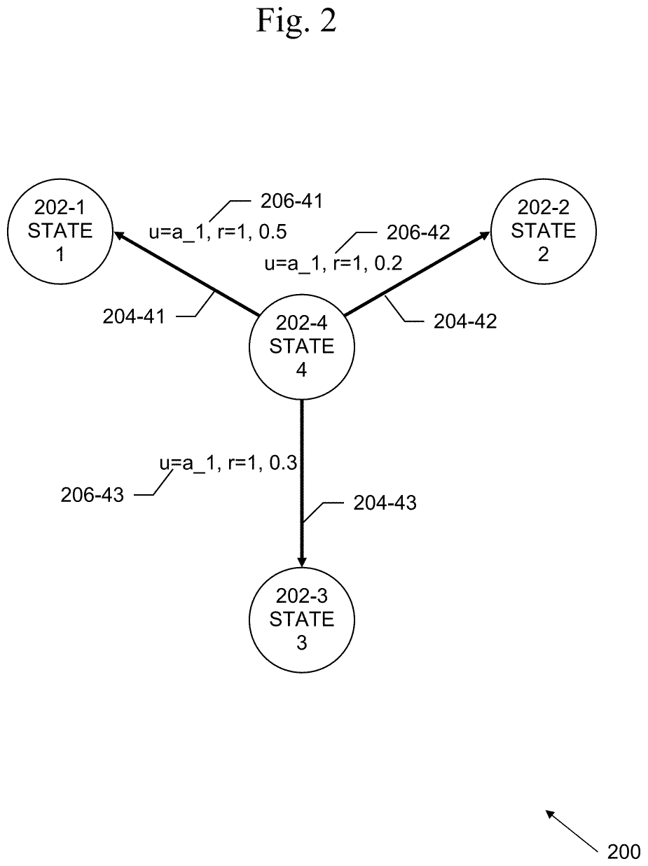

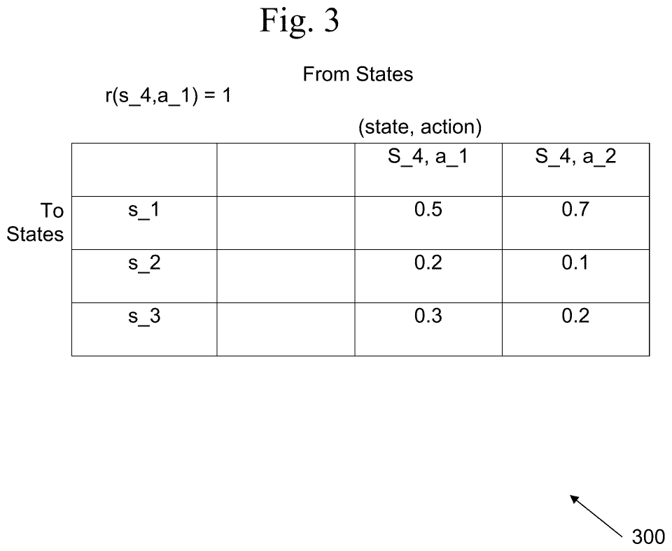

An exemplary flow diagram of processing 100, accordance with embodiments of the present techniques, is shown in FIG. 1. Process 100 may begin with 102, in which, input data, which may include historical data and domain knowledge of a client, such as the mathematical properties of features, may be provided. For example, such mathematical properties may include the continuality of gap to optimality feature or continuality of convergence rate feature. Using the input data, an intermediate model providing a probabilistic description of the environment may be defined as a directed weighted graph G=(V,E), an example of which is shown in FIG. 2. For example, V may represent a set of states, such as states 202-1, 202-2, 202-3, and 202-4, and E may represent transitions, such as 204-41, 202,42, and 204-43, that are weighted, such as 206-41, 206-42, and 206-43, for example, using three parameters corresponding to an action, transition probability, and reward/cost. An equivalent representation of an MDP may be estimated by a transition probability matrix 300 and corresponding vector of costs, as shown in FIG. 3. Each column in matrix 300 corresponds to pair of state=s and action=u. In the present disclosure we use graph G and a transition probability matrix for the same purposes interchangeably. The column entries represent states' distribution to where the process will go based on a given pair of (s, u). Cost/reward may be defined per each pair of (s, u). Thus, at 104 of FIG. 1, transition probability matrix 300 may be estimated using historical data and available domain knowledge. An example of a process of estimating a transition probability matrix 300 is described in U.S. Pat. No. 10,540,598, issued Jan. 21, 2020, and entitled “Interpolation of Transition Probability Values in Markov Decision Processes,” the contents of which are incorporated herein in their entirety. Embodiments may include multiple such matrices for multiple sub-environments.

In order to estimate transition probability matrix 300, historical data may be interpolated to obtain more meaningful data. For example, neighboring state interpolation maybe used, in which historical state related transitions data of a first state may be used to estimate state related transitions under the same actions for one or more neighboring states. Likewise, absorbing state adjustment may be performed, in which misleading samples may be cleaned. For example, one sample may indicate that under some action a first state is absorbing, but, if from domain knowledge it is known that the only absorbing state is a second state, then the misleading samples, such as due to data shortage, may be eliminated. Further, neighboring state interpolation for action independent variables may be performed. For example, whatever action is taken, it should not impact transitions of action independent variables. In addition, irreducibility adjustment may be performed. For example, there may be a single connected component under any policy. It may be possible to simplify the math in this situation, but this may not always be the case. Thus, if the math is incorrectly simplified, this may lead to incorrect recommendations.

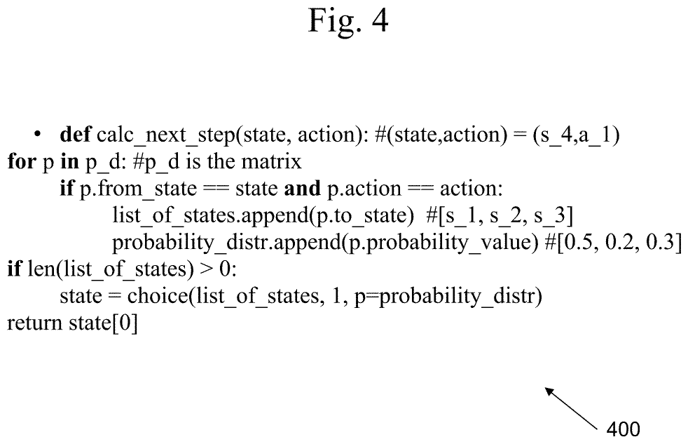

At 108, an initial state of the process may be chosen. In embodiments, the initial state may be chosen randomly, while in other embodiments, the initial state may be chosen deterministically. For example, an initial state may be known up-front, such as given a periodic process that starts at the same state at the same time of the day. At 110, at every time step, a next state transition may be generated according to transition probability matrix 300 and the chosen action. For example, an exemplary process 400 for next state transition generation is shown in FIG. 4. This process may be run as many times as is needed to generate the intermediate model. At 112, the current state, next state, action, and reward for the transition, which were generated at 110 by process 400, may be recorded. At 114, Reinforcement Learning (RL)/Deep Reinforcement Learning (DRL) techniques may be used generate an intermediate model that approximately models the environment, and which has learned from the transition probability matrix 300. The specific RL/DRL technique that may be used may be selected based on which technique provides the best fit. For example, Safe-RL and Constrained DRL are may provide an appropriate fit. At 116, the system, including the intermediate model may be deployed to a client, to a production environment, etc. At 118, intermediate model may continue learning from the real environment during the client's use with the RL/DRL technique.

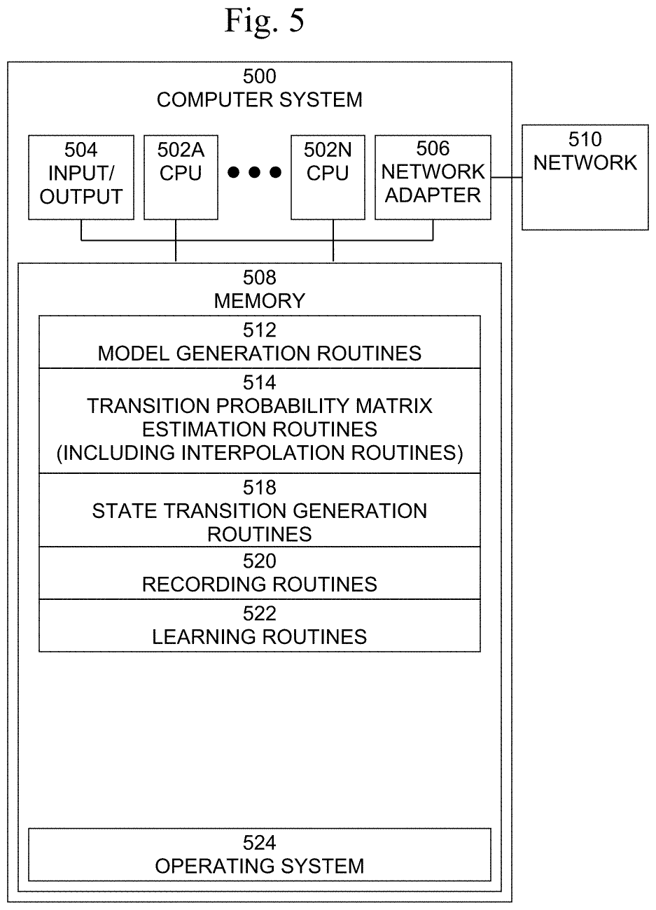

An exemplary block diagram of a computer system 500, in which processes involved in the embodiments described herein may be implemented, is shown in FIG. 5. Computer system 500 may be implemented using one or more programmed general-purpose computer systems, such as embedded processors, systems on a chip, personal computers, workstations, server systems, and minicomputers or mainframe computers, or in distributed, networked computing environments. Computer system 500 may include one or more processors (CPUs) 502A-502N, input/output circuitry 504, network adapter 506, and memory 508. CPUs 502A-502N execute program instructions in order to carry out the functions of the present communications systems and methods. Typically, CPUs 502A-502N are one or more microprocessors, such as an INTEL CORE® processor. FIG. 5 illustrates an embodiment in which computer system 500 is implemented as a single multi-processor computer system, in which multiple processors 502A-502N share system resources, such as memory 508, input/output circuitry 504, and network adapter 506. However, the present communications systems and methods also include embodiments in which computer system 500 is implemented as a plurality of networked computer systems, which may be single-processor computer systems, multi-processor computer systems, or a mix thereof.

Input/output circuitry 504 provides the capability to input data to, or output data from, computer system 500. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 506 interfaces device 500 with a network 510. Network 510 may be any public or proprietary LAN or WAN, including, but not limited to the Internet.

Memory 508 stores program instructions that are executed by, and data that are used and processed by, CPU 502 to perform the functions of computer system 500. Memory 508 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 508 may vary depending upon the function that computer system 500 is programmed to perform. In the example shown in FIG. 5, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 5, memory 508 may include model generation routines 512, transition probability matrix estimation routines 514, interpolation routines 516, state transition generation routines 518, recording routines 520, learning routines 522, and operating system 524. Model generation routines 512 may include software routines to generate an intermediate model, as described above. Transition probability matrix estimation routines 514 may include software routines to generate a transition probability matrix and corresponding vector of costs, as described above. Interpolation routines 516 may include software routines to interpolate historical data, as described above. State transition generation routines 518 may include software routines to interpolate historical data, as described above. Recording routines 520 may include software routines to record the current state, next state, action, and reward for the transition, as described above. Learning routines 522 may include software routines to generate an intermediate model that approximately models the environment, and which has learned from the transition probability matrix, as described above. Operating system 524 may provide overall system functionality.

As shown in FIG. 5, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method, implemented in a computer system comprising a processor, memory accessible by the processor, and computer program instructions stored in the memory and executable by the processor, the method comprising:
identifying historical data and domain knowledge of a client including mathematical properties of features;
generating an intermediate model comprising a probabilistic description of the environment based on the identified historical data and domain knowledge;
training a Reinforcement Learning (RL)/Deep Reinforcement Learning (DRL) model using the generated intermediate model; and
deploying the trained Reinforcement Learning (RL)/Deep Reinforcement Learning (DRL) model and continuing training the trained Reinforcement Learning (RL)/Deep Reinforcement Learning (DRL) model from a real environment.

2. The method of claim 1, wherein generating an intermediate model comprises:
generating the probabilistic description of the environment by estimating at least one transition probability matrix of a Markov Decision Process using the identified historical data and domain knowledge;
selecting an initial state of the process;
generating at least one next state transition; and
recording the generated at least one next state transition.

3. The method of claim 2, wherein the at least one transition probability matrix is estimated by interpolating the identified historical data.

4. The method of claim 3, wherein the interpolating the identified historical data comprises at least one of neighboring state interpolation, absorbing state adjustment, neighboring state interpolation for action independent variables, and irreducibility adjustment.

5. The method of claim 2, wherein:
the at least one next state transition is generated according to the transition probability matrix, a current state, and a chosen action; and
recording the generated at least one next state transition comprises recording a current state, a next state, a chosen action, and a reward.

6. The method of claim 2, wherein at least one transition probability matrix comprises pairs of states and actions and an immediate cost or reward is defined for each state and action pair.

7. The method of claim 2, wherein the initial state of the process is selected either deterministically or randomly.

8. A system comprising a processor, memory accessible by the processor, and computer program instructions stored in the memory and executable by the processor to perform:
identifying historical data and domain knowledge of a client including mathematical properties of features;
generating an intermediate model comprising a probabilistic description of the environment based on the identified historical data and domain knowledge;
training a Reinforcement Learning (RL)/Deep Reinforcement Learning (DRL) model using the generated intermediate model; and
deploying the trained Reinforcement Learning (RL)/Deep Reinforcement Learning (DRL) model and continuing training the trained Reinforcement Learning (RL)/Deep Reinforcement Learning (DRL) model from a real environment.

9. The system of claim 8, wherein generating an intermediate model comprises:
generating the probabilistic description of the environment by estimating at least one transition probability matrix of a Markov Decision Process using the identified historical data and domain knowledge;
selecting an initial state of the process;
generating at least one next state transition; and
recording the generated at least one next state transition.

10. The system of claim 9, wherein the at least one transition probability matrix is estimated by interpolating the identified historical data.

11. The system of claim 10, wherein the interpolating the identified historical data comprises at least one of neighboring state interpolation, absorbing state adjustment, neighboring state interpolation for action independent variables, and irreducibility adjustment.

12. The system of claim 9, wherein:
the at least one next state transition is generated according to the transition probability matrix, a current state, and a chosen action; and
recording the generated at least one next state transition comprises recording a current state, a next state, a chosen action, and a reward.

13. The system of claim 9, wherein at least one transition probability matrix comprises pairs of states and actions and an immediate cost or reward is defined for each state and action pair.

14. The system of claim 9, wherein the initial state of the process is selected either deterministically or randomly.

15. A computer program product comprising a non-transitory computer readable storage having program instructions embodied therewith, the program instructions executable by a computer, to cause the computer to perform a method comprising:
identifying historical data and domain knowledge of a client including mathematical properties of features;
generating an intermediate model comprising a probabilistic description of the environment based on the identified historical data and domain knowledge;
training a Reinforcement Learning (RL)/Deep Reinforcement Learning (DRL) model using the generated intermediate model; and
deploying the trained Reinforcement Learning (RL)/Deep Reinforcement Learning (DRL) model and continuing training the trained Reinforcement Learning (RL)/Deep Reinforcement Learning (DRL) model from a real environment.

16. The computer program product of claim 15, wherein generating an intermediate model comprises:
generating the probabilistic description of the environment by estimating at least one transition probability matrix of a Markov Decision Process using the identified historical data and domain knowledge;
selecting an initial state of the process;
generating at least one next state transition; and
recording the generated at least one next state transition.

17. The computer program product of claim 16, wherein the at least one transition probability matrix is estimated by interpolating the identified historical data.

18. The computer program product of claim 17, wherein the interpolating the identified historical data comprises at least one of neighboring state interpolation, absorbing state adjustment, neighboring state interpolation for action independent variables, and irreducibility adjustment.

19. The computer program product of claim 16, wherein:
the initial state of the process is selected either deterministically or randomly;
the at least one next state transition is generated according to the transition probability matrix, a current state, and a chosen action; and
recording the generated at least one next state transition comprises recording a current state, a next state, a chosen action, and a reward.

20. The computer program product of claim 16, wherein at least one transition probability matrix comprises pairs of states and actions and an immediate cost or reward is defined for each state and action pair.
